(19) United States
(12) Patent Application Publication
(10) Pub. No.: US 2007/0169848 A1
(43) Pub. Date: Jul. 26, 2007

(54) Chipping machine with cutting blades and method for fabricating the cutting blades

(76) Inventors: Wolfgang Holzer, Wallhalben (DE); Thomas Freichel, Lebach (DE)

Correspondence Address: WILLIAM COLLARD;COLLARD & ROE, P.C., 1077 NORTHERN BOULEVARD, ROSLYN, NY, 11576, US

(21) Appl. No.: 11/338,157

(22) Filed: Jan. 24, 2006

(30) Foreign Application Priority Data
Jan. 24, 2006 (DE) 10 2005 003 366.0

(51) Int. Cl. B27C 1/00; B27G 13/00; B27C 5/00

(52) U.S. Cl. 144/220; 144/218; 144/162.1

(57) ABSTRACT

A cutting blade for a chipping machine, with the cutting blades being designed so that splitting blades extending at least essentially perpendicular to a cutting edge of the cutting blade are present, which project beyond the cutting edge and/or stand out from the cutting edge. The cutting blade consists of a blade support and a blade head, with the blade head corresponding with a friction fit to the blade support, and with the blade head being designed as a disposable component.

### BACKGROUND OF THE INVENTION

1. Field of the Invention

This invention relates to a chipping machine with cutting blades according to the preamble of claim 1 and a method for fabricating the cutting blades.

2. The Prior Art

Such cutting blades are known on the market, and are described, for example, in DE 102 19 455 A1.

In that case, a cutting blade as fastened to the inside of the outer envelope of a cylindrical rotor; it is positioned on the rear end of discharge openings for the chipped product. The product to be chipped is inserted into the rotor in the axial direction of the rotor. The rotor can be shifted parallel to its axis of rotation. While in operation, therefore, the product to be chipped is inserted into the rotor in a first step. The product to be chipped is inserted far enough to just fill the rotor. The rotor is shifted in parallel to correspond with the amount of material removed from the product to be chipped. This occurs until the product to be chipped located in the rotor is completely chipped. The rotor is then moved back again to the starting position. The work is then continued again with the operating step in which the product to be chipped is inserted into the rotor.

Splitting blades are also fastened to the cutting blades. The product to be chipped is split by the splitting blades so that chips of a largely well-defined size are formed, corresponding to the blade depth of the cutting blades and the spacing of the splitting blades.

The cutting blades are oriented in the axial direction of the rotor, while the splitting blades are oriented perpendicular to the cutting blades.

The cutting blades are made as solid plates that can be dismantled from the chipper for resharpening. The splitting blades are added to the cutting blades by leaving material in the edge of the blades during the sharpening of cutting blades, by grinding the blade edge leaving material that constitutes the splitting blades. It is therefore necessary during the regrinding to operate the grinder exactly right, so that the material that forms the splitting blades is left in place as well-defined as possible, so that the splitting blades are then sufficiently sharp. To avoid any problems with regard to burnout of the splitting blades during their fabrication from overheating the material, the grinding process has to be appropriately slow, so that the heat produced can be carried off. Note that little material is left right in the area of the splitting blades so that heat removal there is correspondingly difficult. In the known method, furthermore, the cutting blade has to be realigned after sharpening because of the associated removal of material, in order to be able again to cut off chips of the defined size.

### SUMMARY OF THE INVENTION

The task underlying this invention is to simplify the work involved with regard to the cutting blades.

This task is accomplished by the invention by providing that the cutting blade consists of a blade support and a blade head, with the blade head corresponding with the blade support for a friction fit, and with the blade head being designed as a disposable component.

Therefore, the parts mechanically stressed during the cutting process are advantageously designed as disposable items. Because the cutting blade consists of a blade support and a blade head, the sizes of the parts that have to be replaced after wear during the running operation are kept relatively small. This beneficially saves material, by changing only the blade head during maintenance, which is correspondingly limited in size.

Assembly is also simplified by making the blade head to correspond by friction fit with the blade support, because setting the blade head onto the blade support is accomplished in a definite position. The blade support and blade head, for example, can then correspond to one another through a dovetail guide. There can then be a dovetail-shaped groove on the bottom or top face of the blade head, by means of which the blade head is pushed onto a corresponding receptacle in the blade support. If the blade head, besides being fastened on the blade support, is additionally stabilized by a compressive force, it is found with such a dovetail guide that the blade head is still held on the blade support, for example, when the compressive force is deactivated during maintenance to change the blade head. The blade head can then be taken out in a defined way without the blade head being able to fall down uncontrolled.

By making the blade parts as disposable blades, a better-defined size of the product to be chipped is achieved after it is chipped. The size of the blades is changed by resharpening the blades because of material removal. Especially after multiple regrinding processes, the blade size has been so greatly changed that the chipped product then has a different size than when using brand new blades. This size change of the cutting blade according to the state of the art has to be compensated for after several grinding processes by a realignment of the individual cutting blades.

This realignment of the blade support is eliminated by the present invention as long as the blade heads are fabricated with sufficient precision.

In one embodiment, the blade head has cutting edges both on the front face and on the back face, with the face of the blade head corresponding to the blade support being designed to be axially symmetrical with the central longitudinal axis of the blade head.

This therefore beneficially saves more material, specifically because the individual cutting edges of the blade head are designed as disposable blades, but with the blade head having two cutting edges. By rotating the cutting head, therefore, it can be used for two maintenance intervals. With regard to the rotating of the blade head, it also proves to be advantageous for the corresponding face to be of axially symmetrical design so that the blade head can be fastened in both positions, and the blade head is attached in both positions so that the chips have a defined size because of the position of the cutting edges.

In another embodiment, the splitting blades are fastened to the blade head. Because of this, material can advantageously be spared compared to a configuration in which the splitting blades are ground or milled out of the blade head.

They can be fastened by a friction fit (for example by dovetailing), compression forming (for example by sintering or forging), soldered, or cemented. It is also possible to combine a friction fit with another method of fastening.

In another embodiment, the splitting blades are fabricated to be integral with the blade head.

The splitting blades can be ground or milled on. Actually, more material is consumed by this machining process by the material cut out to produce the blade heads. However, by making the splitting blades in one part from the blade head, problems with attachment and mounting can be largely avoided.

In a further embodiment, the splitting blades are produced by deforming the material of the blade head in the area of the cutting edge of the blade head.

In this case, therefore, it proves to be particularly advantageous for the blade head to be designed as a disposable item and for it to correspond with a blade support. This correspondingly limits the material thickness of the blade head, so that for example, in the fabrication of the blade head or in a subsequent machining step, the splitting blade can be pressed out of the blade head by appropriate mechanical impact on the blade head in the area of the cutting edges. This pressing can be forming or swaging.

As the case may be, the splitting blades may have to be resharpened after being pressed out of the material of the blade head.

However, it is also possible to achieve the forming of the material in the area of the cutting edge by a different machining method. This can also be a roller process (rolling), for example. In the configuration according to claim 6, the splitting blades have constant lateral spacing.

Because of this, the pieces of chipped product beneficially have at least nearly uniform size.

In yet a further embodiment, the blade head and the blade support correspond to one another so that when the blade head is mounted, the front edge of the blade support is covered by the blade head in the area of the advancing material.

In this way, material wear on the blade support in the area of the front edge can advantageously be avoided. Appropriate mechanical loading of the blade head in this area presents no further problems, since the blade head as a wear part is subject to regular replacement anyhow.

The covering can be accomplished, for example, by providing that the front face of the blade support constitutes a contact surface of a key over which a dovetail-shaped groove on the bottom face of the blade head is pushed. One face of the dovetail-shaped groove then covers the front edge of the blade support.

The invention also relates to a method for fabricating a blade head of a cutting blade with a splitting blade, in which the cutting edge of the blade head is produced in a first operating step, with the splitting blade being produced in a subsequent operating step by material deformation of the blade head in the area of the cutting edge of the blade head.

In this case, therefore, it proves to be particularly advantageous for the blade head to be designed as a disposable item and for it to correspond with a blade support. This correspondingly limits the material thickness of the blade head, so that for example, in the fabrication of the blade head or in a subsequent machining step, the splitting blade can be pressed out of the blade head by appropriate mechanical impact on the blade head in the area of the cutting edges. This pressing can be forming or swaging.

As the case may be, the splitting blades may still have to be sharpened after being pressed out of the material of the blade head.

However, it is also possible to achieve the forming of the material in the area of the cutting edge by a different machining method. This can also be a rolling process, for example.

### BRIEF DESCRIPTION OF THE DRAWINGS

The drawing shows an example of embodiment of the invention. In detail, the Figures show:

FIG. 1 shows an illustration of a chipping device in a plan view in the direction of transport of the product to be chipped;

FIG. 2 shows a plan view of a first embodiment of a blade head;

FIG. 3 shows the blade head of FIG. 2 in side view;

FIG. 4 shows a plan view of another embodiment of a blade head;

FIG. 5 shows the blade head of FIG. 4 in side view; and

FIG. 6 shows an embodiment of a blade head and a blade support.

### DETAILED DESCRIPTION OF THE PREFERRED EMBODIMENTS

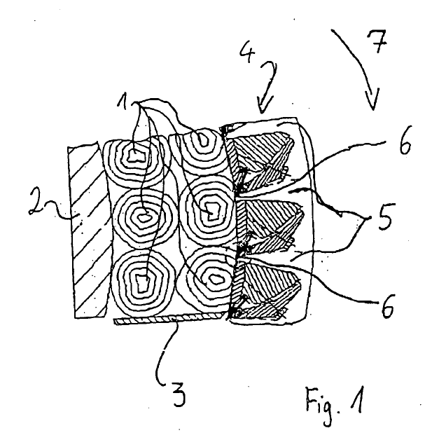

FIG. 1 shows an illustration of a chipping device in plan view in the direction of transport of the material to be chipped. The product to be chipped in the present case is tree trunks 1. These are held by a contact wall 2 on the side and by a base part 3.

A part of the envelope of the cylindrical rotor 4 can also be seen. The axis of rotation of the cylindrical rotor 4 in the example of embodiment shown is perpendicular to the plane of the drawing. The axis of rotation runs parallel to the direction of feed of the product 1 to be chipped.

In the longitudinal direction, the envelope of the cylindrical rotor 4 has opening gaps 5 as discharge openings. There are cutting blades 6 at the rear ends of the opening gaps 5 viewed in the direction of rotation, on the inside of the envelope, which in turn are oriented in the longitudinal direction of the cylindrical rotor 4.

The direction of rotation is indicated by the arrow 7.

The product 1 to be chipped is then chipped by shifting the axis of rotation of the cylindrical rotor 4 in parallel. The illustrated portion of the envelope of the cylindrical rotor 4 is shifted toward the lateral contact wall 2. The product 1 to be chipped is thereby chipped little by little from the face of the envelope of the cylindrical rotor 4 toward the lateral contact wall 2, corresponding to the speed of advance of the axis of rotation of the cylindrical rotor 4.

The chips of the product 1 to be chipped lifted by the cutting blades 6 during rotation pass through the opening gaps 5 to the outside.

Splitting blades perpendicular to the cutting blades 6 also extend into the opening gaps 5. The chips of the product 1 to be chipped entering the opening gaps are again subdivided by these splitting blades.

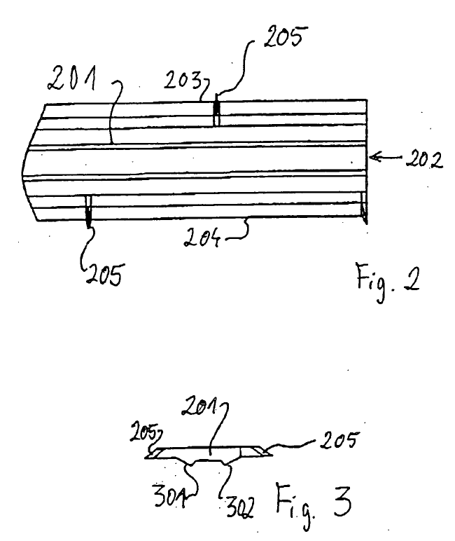

FIG. 2 shows an example of embodiment of a blade head 201 in plan view. It can be seen that the blade head 201 has mirror symmetry with respect to its central longitudinal axis 202. This is advantageous because the blade head 201 has two edges 203 and 204 that can be used as cutting edges. When one of the cutting edges 203 has become worn during operation after installing the blade head 201, the blade head 201 can advantageously be rotated because of the symmetrical construction, so that work can be continued with the other cutting edge 204. When this cutting edge 204 has also become worn, the blade head 201 is replaced.

It proves to be beneficial here for the blade head 201 to have limited dimensions so that the material consumption from changing the blade head 201 is kept small. Since the cutting edges 203, 204 are not reground, it is also beneficial that no great material thicknesses are needed for the blade head 201.

FIG. 2 also shows that splitting blades 205 are present; in the embodiment shown, they are attached to the blade head 201. The splitting blades 205 can advantageously be attached by mechanical fit, for example by means of dovetail guidance. Alternatively, or in addition, these splitting blades 205 can be additionally fastened, for example by means of form pressing (for example by sintering or forging), or they can also be soldered or cemented in place.

In the example of embodiment shown, the splitting blades 205 extend beyond the cutting edges 203 and 204. The splitting blades 205 in this example of embodiment therefore project beyond the cutting edges 203, 204.

FIG. 3 shows the blade head from the illustration of FIG. 2 in a lateral cross section, where it can be seen by the lugs 301, 302 that the bottom face of the blade head corresponds with a blade support. This blade support is not shown here. It can be seen that the blade head, through the lugs 301, 302, is fixed in position laterally. Simple withdrawal of the blade head is made possible. In particular, it can be simply set down and centered by the lugs 301 and 302 themselves. Slight dirtying likewise plays no role. The blade head can nevertheless be mounted and disassembled relatively easily.

The blade support is a separate component to which the blade head is fastened, with the cutting blade then being composed of the blade support with the blade head. The blade support can advantageously be attached to the chipping device and aligned. The blade heads can then advantageously be attached to the assembled blade support so that no new alignment is necessary when changing the blade head.

It can be seen that the lugs 301 and 302 are designed with axial symmetry to the central longitudinal axis of the blade head, so that even when the blade head is rotated to use the other cutting edge, the blade head corresponds in friction fit to the blade support.

FIG. 4 shows another example of embodiment of a blade head 401 in plan view. Here also the blade head 401 has mirror symmetry with respect to its central longitudinal axis 402. The result here also is that the blade head 401 has two edges 403 and 404 that can be used as cutting blades. When one of the cutting edges 403 has worn during operation after installing the blade head 401, the blade head 401 can advantageously be rotated because of the symmetrical construction, so that work can be continued with the other cutting edge 404. When this cutting edge 404 has also become worn, the blade head 401 is replaced.

It proves here to be beneficial for the blade head 401 to have limited dimensions so that material consumption from changing the blade head 401 is kept small. Since the cutting edges 403, 404 are not reground, it is beneficial that no large material thicknesses are needed for the blade head 401.

FIG. 4 also shows that splitting blades 405 are present, which in the example shown can be machined out of the blade head 401 by removing material. This can be done by machining these splitting blades 405 by grinding or milling them out of the blade head 401. It is beneficial that this causes no problems with the mounting of the splitting blades in the blade head. Since the splitting blades 405 are machined out of the blade support, the splitting blades 405 in this embodiment also do not project beyond the cutting edges 403 and 404. The splitting blades 405 extend out of the blade head 401 only in the vertical direction.

Alternatively, the splitting blades can also be produced by being pressed out from the bottom face of the blade head 401 by mechanical impact. The splitting blades 405 may then still have to be sharpened. The splitting blades 405 can also be machined out of the cutting edges 403, 404 by material deformation in a rolling process. In case of this machining, therefore, it proves to be especially beneficial that the blade head 401 can be produced at low cost. In particular, the cutting edges can be produced first in a first operating step, from which the splitting blades 405 can then be pressed out. No problems arise from the successive subsequent machining steps to produce the splitting blades 405 in this case if the splitting blades 405 are “left standing” when material is removed to produce the cutting edges 403, 404. By designing the blade head 401 as a disposable component, it also has suitably small material thickness, so that pressing out the splitting blades 405 is advantageously as simple as possible.

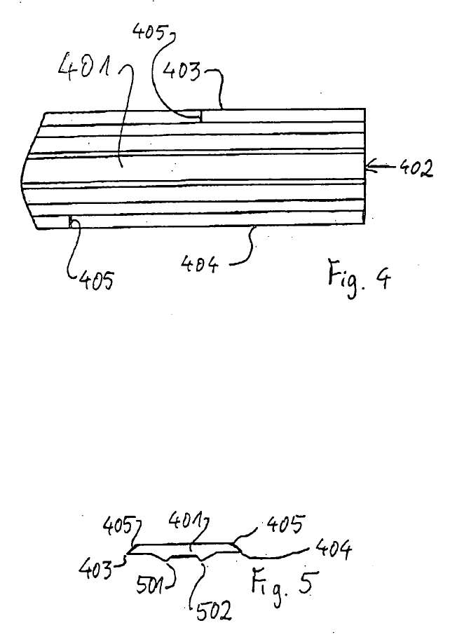

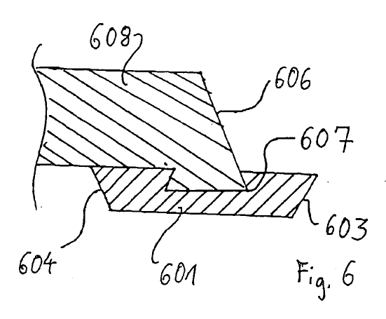

FIG. 5 shows the blade head 401 from the illustration of FIG. 4 in a lateral cross section; it can be seen that the bottom face of the blade head corresponds with a blade support by means of the lugs 501, 502. This blade support is not shown here. The blade head can also be set in place relatively easily with these lugs 501, 502.

The blade support is a separate component to which the blade head is fastened, with the cutting blade then being composed of the blade support and the blade head. The blade support can advantageously be attached and aligned to the chipping device. The blade heads can then advantageously be attached to the mounted blade support so that no realignment is necessary when changing the blade head.

It can be seen that the lugs 501 and 502 are designed to be axially symmetrical with respect to the central longitudinal axis of the blade head 401, so that even when the blade head 401 is rotated to use the other cutting edge, it is assured that the blade head 401 corresponds with a friction fit to the blade support.

FIG. 6 shows a blade head 601 and a blade support 608. This blade support 608 is mounted on the chipping device. It can be seen that a dovetail-shaped receptacle is provided in the area of the forward edge 607 of the blade support 608 for a dovetail-shaped groove of the blade head 601. After mounting the blade head 601, the forward edge 607 is covered. The size of the chips is essentially codetermined by the overhang of the blade head 601 beyond the forward face 606 of the blade support. The separated chips run up there, and then break off as a result of bending.

Covering the forward edge 607 with the blade head 601 beneficially avoids wear of the forward edge 607 from material ascending there.

The fastening of the blade head 601 is beneficially improved by the dovetail-shaped receptacle of the blade head 601. Of course it must be noted that increasing dirtying of the machine can make it more difficult to change the blade heads 601. This is associated with the accurate fitting that is necessary to push the dovetail-shaped receptacle of the blade head 601. This accurate fit also demands correspondingly smaller tolerances.

The illustrated examples of embodiment have shown that the receptacle of the blade head is made on its bottom face. However, depending on the attachment of the blade head, this receptacle can also be made on the top face. It is also not compulsory for the splitting blades to be attached so that they are in the discharge openings of the chipping device. Instead, the splitting blades can also be so provided that these splitting blades already split the wood as the rotor rotates, so that the subdivided chips are then formed immediately when the chips are lifted off.

What is claimed is:

1. Chipping machine with cutting blades, each cutting blade comprising:
a blade support; and
a disposable blade head, the blade head being inserted with a friction fit to the blade support;
wherein the cutting blade has splitting blades extending substantially perpendicular to a cutting edge of the cutting blade, said splitting blades projecting beyond the cutting edge or standing out from the cutting edge,.

2. A chipping machine with cutting blades pursuant to claim 1, wherein the blade head has a cutting edge on its front face and another cutting edge on its rear face, and wherein a face of the blade head corresponding to the blade support is axially symmetrical with respect to a central longitudinal axis of the blade head.

3. A chipping machine with cutting blades pursuant to claim 1, wherein the splitting blades are fastened to the blade head.

4. A chipping machine with cutting blades pursuant to claim 1, wherein the splitting blades are integral with the blade head.

5. A chipping machine with cutting blades pursuant to claim 4, wherein the splitting blades are made in the cutting edge of the blade head by deforming material of the blade head.

6. A chipping machine with cutting blades pursuant to claim 1, wherein the splitting blades have constant lateral spacing from each other.

7. A chipping machine with cutting blades pursuant to claim 1, wherein the blade head and the blade support correspond to one another so that when the blade head is mounted in the blade support, a forward edge of the blade support is covered by the blade head in an area of ascending material.

8. Method for fabricating a blade head of a cutting blade of a chipping machine with a splitting blade, comprising the following steps:
producing a cutting edge of a blade head in a first operating step;
producing a splitting blade in a subsequent operating step by material deformation of the blade head in areas of the cutting edge of the blade head.
